(19) United States
(12) Patent Application Publication
(10) Pub. No.: US 2019/0087426 A1
(43) Pub. Date: Mar. 21, 2019

(54) SYSTEMS AND METHODS FOR PROVIDING QUERY RESULTS BASED ON EMBEDDINGS

(71) Applicant: Facebook, Inc., Menlo Park, CA (US)

(72) Inventors: Komal Kapoor, Bellevue, WA (US); Bradley Ray Green, Snohomish, WA (US); Yunzhi Ye, Seattle, WA (US); Yixin Li, Kirkland, WA (US)

(21) Appl. No.: 15/707,113

(22) Filed: Sep. 18, 2017

(51) Int. Cl. G06F 17/30; G06F 17/14; G06F 17/15

(52) U.S. Cl. CPC G06F 17/3041; G06F 17/30651; G06F 17/175; G06F 17/153; G06F 17/147

(57) ABSTRACT

Systems, methods, and non-transitory computer-readable media can compute a query embedding in a first multi-dimensional space based on a query embedding model. The query embedding is associated with a user query. A plurality of page embeddings are computed in a second multi-dimensional space based on a page embedding model. A query joint embedding and a plurality of page joint embeddings are computed in a third multi-dimensional space based on the query embedding, the plurality of page embeddings, and a joint embedding model. One or more page results are identified for the user query based on the query joint embedding and the plurality of page joint embeddings.

### FIELD OF THE INVENTION

The present technology relates to the field of electronic queries. More particularly, the present technology relates to systems and methods for providing query results based on embeddings.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

A social networking system can include pages that are associated with entities. The pages can be dedicated locations on the social networking system to reflect the presence of the entities on the social networking system. The users and entities associated with such pages can be provided with the opportunity to interact with other users on the social networking system. Users can also be provided with the ability to enter queries (e.g., text queries) to search for pages on the social networking system.

### SUMMARY

Various embodiments of the present disclosure can include systems, methods, and non-transitory computer readable media configured to compute a query embedding in a first multi-dimensional space based on a query embedding model. The query embedding is associated with a user query. A plurality of page embeddings are computed in a second multi-dimensional space based on a page embedding model. A query joint embedding and a plurality of page joint embeddings are computed in a third multi-dimensional space based on the query embedding, the plurality of page embeddings, and a joint embedding model. One or more page results are identified for the user query based on the query joint embedding and the plurality of page joint embeddings.

In an embodiment, computing the query joint embedding comprises mapping the query embedding to the third multi-dimensional space based on the joint embedding model, and computing the plurality of page joint embeddings comprises mapping the plurality of page embeddings to the third multi-dimensional space based on the joint embedding model.

In an embodiment, distance scores are calculated for each page joint embedding with respect to the query joint embedding, and the one or more page results are identified based on the distance scores.

In an embodiment, for a given page joint embedding, the distance score is calculated based on a cosine similarity of the page joint embedding and the query joint embedding.

In an embodiment, the page embedding model is trained based on a neural linguistic embedding methodology.

In an embodiment, the page embedding model is trained using page training data, the page training data comprises a plurality of sentences, each sentence of the plurality of sentences comprises a sequence of words, each sentence of the plurality of sentences is associated with a particular user, and each word in a sentence is associated with a page fanned by the particular user.

In an embodiment, the query embedding model is trained based on query training data comprising a plurality of content posts on a plurality of pages.

In an embodiment, the query embedding model is trained based on a paragraph embedding methodology.

In an embodiment, the query training data comprises a plurality of paragraphs, each paragraph of the plurality of paragraphs comprising a plurality of sentences. For each paragraph in the plurality of paragraphs, the paragraph is associated with a particular page, and each sentence in the paragraph is associated with a content post on the particular page.

In an embodiment, the joint embedding model is trained based on a two-stream x2 neural network methodology.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an embeddings-based page query module, according to an embodiment of the present disclosure.

FIG. 2 illustrates an example vector representation module, according to various embodiments of the present disclosure.

FIG. 3 illustrates an example functional block diagram associated with training a joint embedding model, according to various embodiments of the present disclosure.

FIG. 4 illustrates an example query results module, according to various embodiments of the present disclosure.

FIG. 5 illustrates an example method associated with identifying one or more query results based on embeddings, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Query Results Based on Embeddings

People use computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

The social networking system may provide pages for various entities. For example, pages may be associated with companies, businesses, brands, products, artists, public figures, entertainment, individuals, concepts, and other types of entities. The pages can be dedicated locations on the social networking system to reflect the presence of the entities on the social networking system. A page can publish content that is deemed relevant to its associated entity to promote engagement with the page. Pages on the social networking system may provide users of the social networking system with an opportunity to discover and interact with the various entities associated with the pages.

Under conventional approaches, users may be provided with the ability to enter queries (e.g., textual queries) to search for pages on the social networking system. For example, a user can be provided with a search box within which the user can enter one or more search terms. A set of search results comprising one or more pages can be provided to the user based on the one or more search terms. However, it may be the case that a single entity can be referred to by different names. For example, the publication The New York Times may be referred to as “NY Times,” or “NYT.” When a user enters a query, the user may expect results corresponding to all different forms of an entity name, rather than results that correspond only to the literal terms entered. For example, if a user enters a query for “NYT,” the user may expect to see search results that include a page for “The New York Times.” However, under conventional approaches, a search for the entered search term “NYT” may not result in the page for “The New York Times” being identified as a search result due to differences in the entered query and the page name. In another example, it may be the case that a particular concept and/or entity can be described using different terms. For example, one user looking for end-of-year discounts could enter the query “Christmas deals” while another users may search for “holiday sales.” These users may not be presented with the same search results, despite similar intent in their search queries. In scenarios such as those described above, users may grow frustrated with search results that are perceived as incomplete or inconsistent. Conventional approaches may not be effective in addressing these and other problems arising in computer technology.

An improved approach rooted in computer technology overcomes the foregoing and other disadvantages associated with conventional approaches specifically arising in the realm of computer technology. In general, vector representations (i.e., embeddings) of queries and pages may be mapped to the same latent space, such that vector representations of queries and pages can be directly compared to one another in order to identify one of more pages that most closely match a query. Use of embeddings allows for the identification of semantic similarity between pages and queries without being limited to only the actual terms used in a query. In various embodiments, a page embedding model can be trained, based on page training data, to compute page embeddings for a set of pages in a multi-dimensional page space. A query embedding model can be trained, based on query training data, to compute query embeddings in a multi-dimensional word space. A joint embedding model can be trained, based on page-query training data, to map page embeddings and query embeddings to a multi-dimensional page-query joint space. A page embedding mapped to the page-query joint space may be referred to herein as a page joint embedding, and a query embedding mapped to the page-query joint space may be referred to herein as a query joint embedding. Since page joint embeddings and query joint embeddings are mapped to a common, shared space, they can be compared directly to one another. As such, when a query is received, a query joint embedding can be computed for the query based on the joint embedding model. Similarly, page joint embeddings can be computed for a set of pages based on the joint embedding model. Distance scores can be calculated for the set of page joint embeddings with respect to the query joint embedding. One or more pages can be selected as page results for the query based on the distance scores.

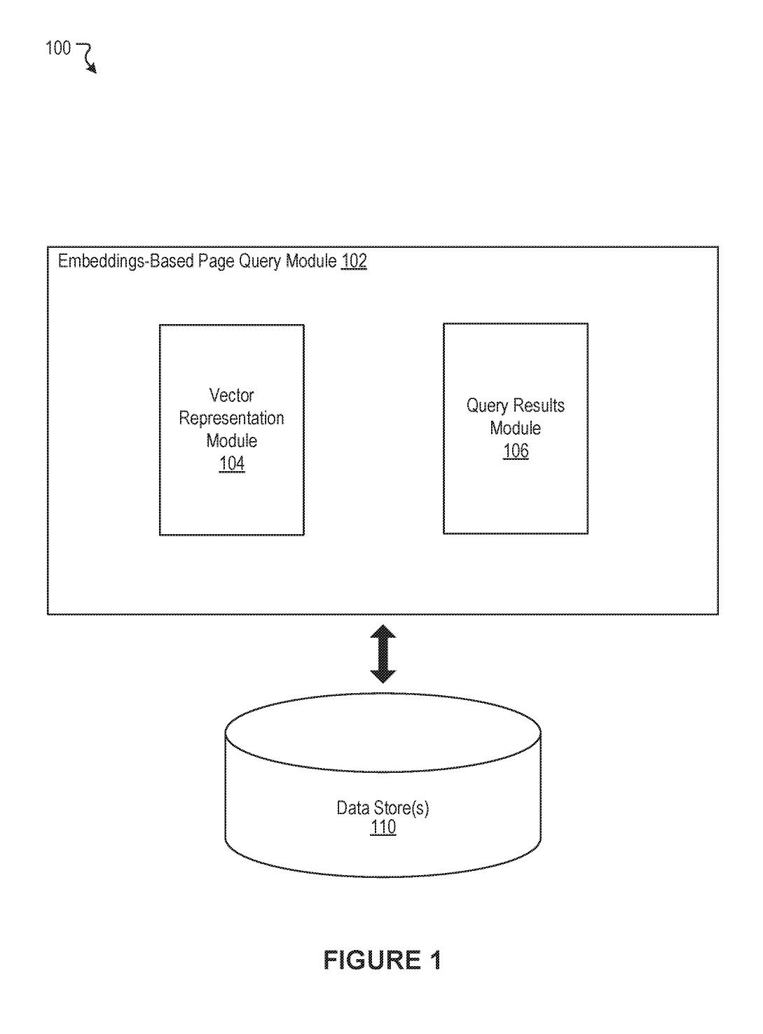

FIG. 1 illustrates an example system 100 including an example embeddings-based page query module 102, according to an embodiment of the present disclosure. The embeddings-based page query module 102 can be configured to receive a query, and to identify one or more page results for the query based on embeddings. In various embodiments, the embeddings-based page query module 102 can train a page embedding model based on page training data. The page embedding model can be trained to compute page embeddings in a multi-dimensional page space for a set of pages. The embeddings-based page query module 102 can train a query embedding model based on query training data. The query embedding model can be trained to compute query embeddings in a multi-dimensional word space. The embeddings-based page query module 102 can train a joint embedding model based on page-query training data. The joint embedding model can be trained to map page embeddings and query embeddings to a multi-dimensional page-query joint space. A page embedding mapped to the page-query joint space may be referred to as a page joint embedding, and a query embedding mapped to the page-query joint space may be referred to as a query joint embedding.

The embeddings-based page query module 102 can be configured to receive a query entered by a user. The embeddings-based page query module 102 can utilize the query embedding model to compute a query embedding based on the query. Similarly, the embeddings-based page query module 102 can receive a set of pages, and can utilize the page embedding model to compute page embeddings for each page in the set of pages. The embeddings-based page query module 102 can then utilize the joint embedding model to map the query embedding and the page embeddings to a page-query joint space. In other words, the query embedding can be mapped to the page-query joint space to yield a query joint embedding, and the page embeddings can be mapped to the page-query joint space to yield page joint embeddings. Distance scores can be calculated for each page joint embedding with respect to the query joint embedding. Distance scores may be based on, for example, a dot product and/or a cosine similarity of each page joint embedding with respect to the query joint embedding. The embeddings-based page query module 102 can be configured to identify one or more pages based on the distance scores. The embeddings-based page query module 102 can provide the one or more pages to the user as results for the query.

As shown in the example of FIG. 1, the embeddings-based page query module 102 can include a vector representation module 104 and a query results module 106. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the embeddings-based page query module 102 can be implemented in any suitable combinations.

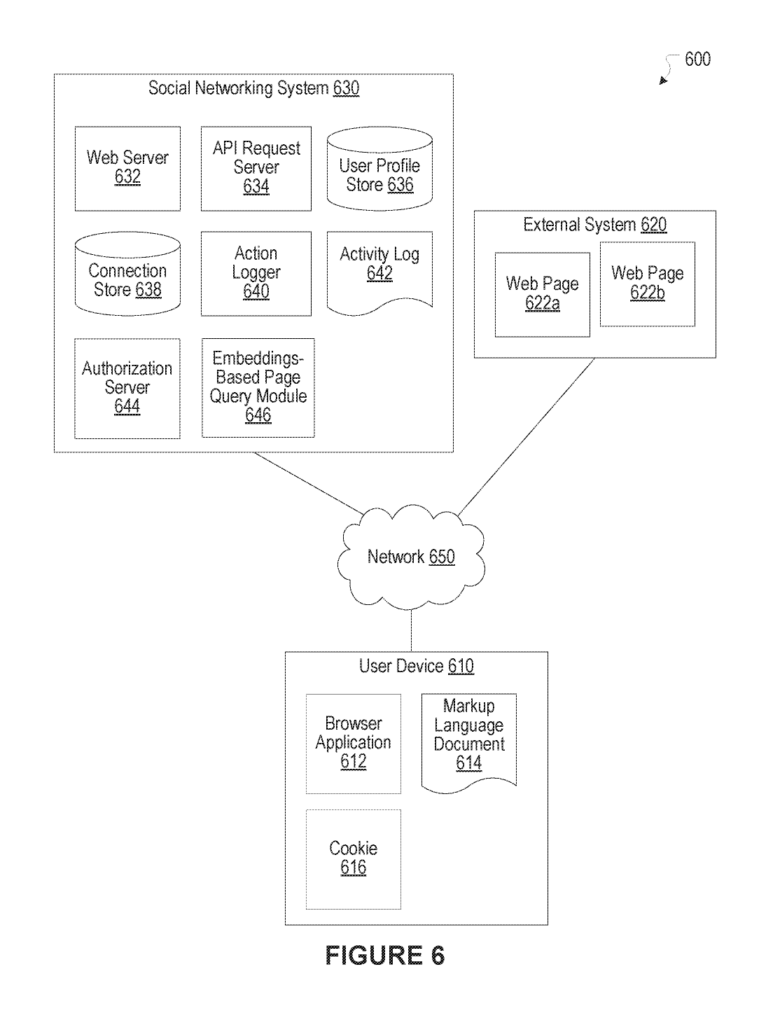

In some embodiments, the embeddings-based page query module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the embeddings-based page query module 102 can be implemented, in part or in whole, as software running on one or more computing devices or systems, such as on a user or client computing device. For example, the embeddings-based page query module 102, or at least a portion thereof, can be implemented as or within an application (e.g., app), a program, or an applet, etc., running on a user computing device or a client computing system, such as the user device 610 of FIG. 6. In another example, the embeddings-based page query module 102, or at least a portion thereof, can be implemented using one or more computing devices or systems that include one or more servers, such as network servers or cloud servers. In some instances, the embeddings-based page query module 102 can, in part or in whole, be implemented within or configured to operate in conjunction with a social networking system (or service), such as the social networking system 630 of FIG. 6. It should be understood that there can be many variations or other possibilities.

The embeddings-based page query module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social engagements, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the embeddings-based page query module 102. For example, the data store 110 can store page embeddings, query embeddings, page joint embeddings, query joint embeddings, page embedding models, query embedding models, joint embedding models, various sets of training data, and the like. It is contemplated that there can be many variations or other possibilities.

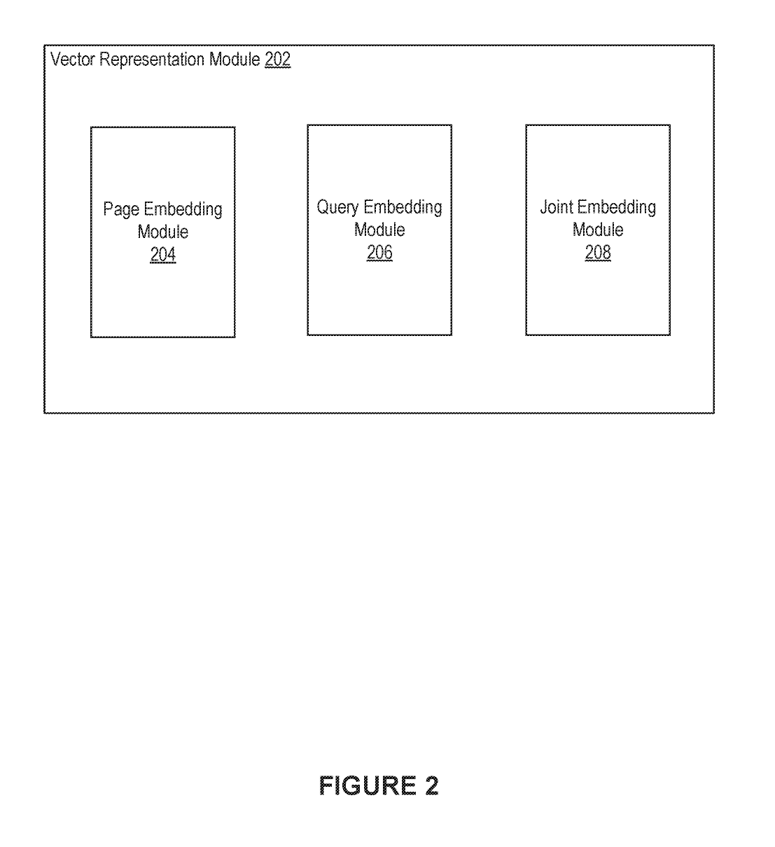

The vector representation module 104 can be configured to compute vector representations, or embeddings, for pages (i.e., page embeddings) in a multi-dimensional page space and for queries (i.e., query embeddings) in a multi-dimensional word space. In various embodiments, the vector representation module 104 can train a page embedding model to compute page embeddings, and can train a query embedding model to compute query embeddings. The vector representation module 104 can also be configured to compute joint embeddings for pages and queries in a multi-dimensional page-query joint space (i.e., page joint embeddings and query joint embeddings). In various embeddings, page joint embeddings can be computed by mapping page embeddings to the page-query joint space, and query joint embeddings can be computed by mapping query embeddings to the page-query joint space. The vector representation module 104 is described in greater detail herein with reference to FIG. 2.

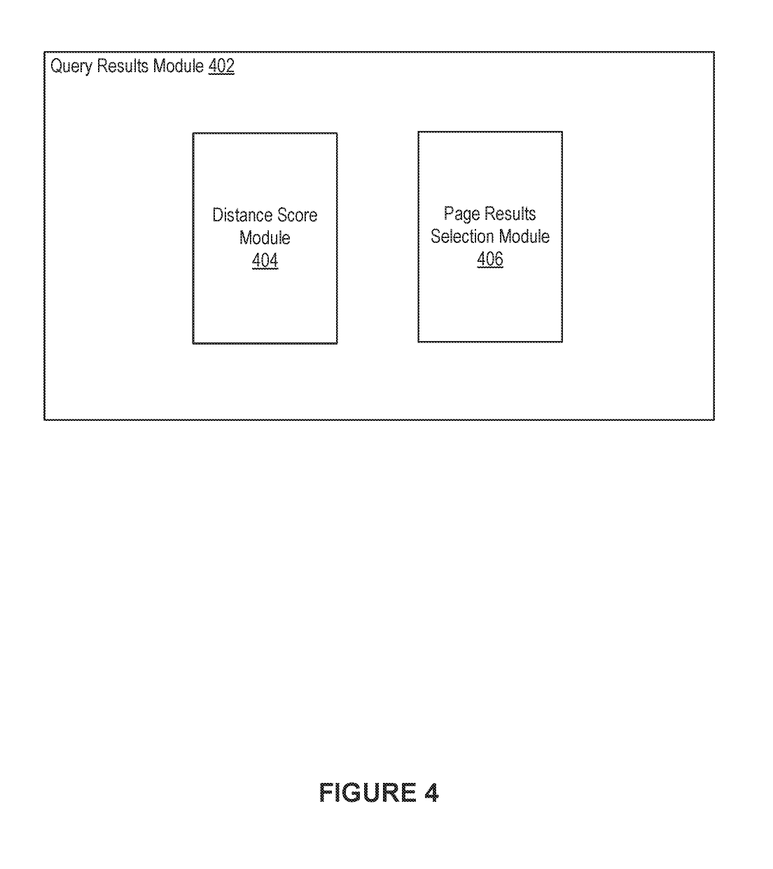

The query results module 106 can be configured to identify one or more results for a query based on embeddings. The one or more results can comprise one or more pages identified as being relevant to the query based on embeddings. In various embodiments, the query results module 106 can compare a query joint embedding associated with the query with a plurality of page joint embeddings, each page joint embedding being associated with a page (e.g., a page on a social networking system). For example, the query results module 106 can calculate distance scores for the plurality of page joint embeddings with respect to the query joint embedding. One or more pages can be identified as results for the query based on the distance scores. The query results module 106 is described in greater detail herein with reference to FIG. 4.

FIG. 2 illustrates an example vector representation module 202 configured to compute embeddings for pages and queries, according to an embodiment of the present disclosure. In some embodiments, the vector representation module 104 of FIG. 1 can be implemented as the vector representation module 202. As shown in the example of FIG. 2, the vector representation module 202 can include a page embedding module 204, a query embedding module 206, and a joint embedding module 208.

The page embedding module 204 can be configured to compute vector representations of pages, i.e., page embeddings, in a multi-dimensional page space. The page embedding module 204 can be configured to train a page embedding model based on page training data. The page embedding model can be trained to compute page embeddings to represent a set of pages. In certain embodiments, page training data used to train the page embedding model can comprise page fanning information. Users of a social networking system can be given the ability to become fans of, or “fan,” pages on the social networking system. Users may tend to fan similar pages together, such that if a given user fans a first page, and then fans a second page, there is a likelihood that the first page and the second page are related to one another. For example, a user might fan a page for Barack Obama, and then fan a page for Michelle Obama. Page fanning information used to train the page embedding model can include one or more sequences of pages that have been fanned by a plurality of users.

In various embodiments, the page embedding module 204 can train the page embedding model to compute page embeddings for pages based on a neural linguistic embedding methodology. Neural linguistic embedding methodologies (e.g., word2vec) can generate an embedding for an individual word based on words surrounding the individual word in a sentence. In the context of generating page embeddings based on page fanning sequences, each “sentence” may be associated with a particular user, and each “word” may represent a page, such that each sentence represents a sequence of pages fanned by a particular user. Each sentence can comprise all pages that have ever been fanned by a particular user, or all pages that have been fanned by a particular user over a period of time (e.g., over the past year). The words in each sentence (i.e., the pages that a user has fanned) can be ordered based on time of fanning (e.g., ordered such that pages that have most recently been fanned by a user are presented first, or pages that have most recently been fanned by a user are presented last). These sentences are then provided to the neural linguistic embedding training model (i.e., the page embedding model) to generate embeddings for each page (i.e., each “word”) in each sentence.

In general, it may be desirable to train with a full window over a sessionized sentence such that all pages in a sentence are embedded based on all other pages in the sentence. However, in certain instances, this may not be practicable or even desirable. As such, a smaller window size may be selected such that for each page in the sentence, the page's embedding is trained based on other pages within the selected window size. For example, consider a user, User A, that has fanned nine pages: page1, page2, page3, page4, page5, page6, page7, page8, page9. If the window size is selected as 1, then the window for page2 would be [page1, page2, page3] and page2's embedding would be trained based on User A′s fanning of page1 and page3. The window may be selected based on any variety of selection criteria, such as a statistical analysis to determine an optimal window size. In various embodiments, for example, the window size may be a window of length 9.

The query embedding module 206 can be configured to compute vector representations of queries, i.e., query embeddings, in a multi-dimensional word space. The query embedding module 206 can be configured to train a query embedding model based on query training data. The query embedding model 206 can be trained to compute query embeddings representative of textual queries. In certain embodiments, query training data used to train the query embedding model can comprise page post information. A page on a social networking system can upload content posts comprising textual information that may be visible to other users on the social networking system. Content posts posted by a page are typically related to a general theme of the page. For example, a page for a coffee shop will likely publish content posts about coffee or other items sold at the coffee shop. As such, words in the content posts of a page tend to be similar and/or related to one another, as they will often refer to the same theme. Query training data for training the query embedding model can include, for example, a set of pages, and content posts by each page in the set of pages. The query embedding model can be trained using these content posts to identify relationships between certain words. A query embedding for a query can be computed based on the words in the query.

In various embodiments, the query embedding module 206 can train the query embedding model to compute query embeddings based on paragraph embedding methodologies (e.g., paragraph2vec). A paragraph, as defined by paragraph embedding methodologies, comprises a sequence of sentences, and each sentence comprises a sequence of words. Paragraph embedding methodologies combine neural linguistic embeddings to generate embeddings for both the words in a paragraph as well as the paragraph itself in the same latent space. In the context of training a query embedding model based on page post information, each paragraph can be associated with a page, each sentence in the paragraph can be associated with a content post on the page, and the words in a sentence can comprise the words in a content post. Paragraphs can be provided to a paragraph embedding training model (i.e., the query embedding model) to generate embeddings for each page in a set of pages and each word used in content posts published to the set of pages.

In various embodiments of the present disclosure, the page embeddings computed as a result of the paragraph embedding methodology can be disregarded, while the word embeddings can be utilized to compute query embeddings. In certain embodiments, a query comprises one or more words. A query embedding can be computed by pooling the word embeddings for words in the query using average pooling. For example, a query embedding can be computed as a sum of embeddings of each word in a query.

The joint embedding module 208 can be configured to compute vector representations of pages (i.e., page joint embeddings) and/or queries (i.e., query joint embeddings) in a multi-dimensional page-query joint space. The joint embedding module 208 can be configured to train a joint embedding model based on page-query training data. The joint embedding model can be trained to compute page joint embeddings and query joint embeddings in the page-query joint space. In certain embodiments, page-query training data used to train the joint embedding model can comprise page query result information. When a user enters a query for pages on a social networking system, the user can be presented with a results list comprising a set of pages (i.e., page results) that have been determined to potentially match the user's query. The user can view the results list, and select one or more page results that the user is interested in viewing. The user's selection of a particular page result indicates that the particular page result is likely a good match for the user's query. Page query result information can include a set of queries entered by users, and, for each query, all page results shown to the user, as well as all page results that were selected by the user. Any page results that were selected can represent positive labels, while all other page results (i.e., page results that were not selected) can represent negative labels. The joint embedding model can be trained using the page query result information to identify pages that are most relevant to various queries.

In various embodiments, the joint embedding module 208 can train the joint embedding model to compute page and query joint embeddings based on two-stream x2 neural network (NN) methodologies. In various embodiments, two-stream x2 NN methodologies can be used to map two different sets of embeddings, computed in two different multi-dimensional spaces, into a single, common multi-dimensional space. In the present example, page embeddings computed in a page space and query embeddings computed in a word space can be mapped to a common page-query joint space. The joint embedding model can be trained to map query embeddings as query joint embeddings and to map page embeddings as page joint embeddings in the common page-query joint space. As discussed above, the joint embedding model can be trained using page-query training data. The page query training data can include page query result information, in which, for a given query, page results that are selected by a user are given positive labels, and all other page results are given negative labels. In some embodiments, negatively labeled page results can be undersampled so as to achieve a more balanced distribution of negative and positive labels.

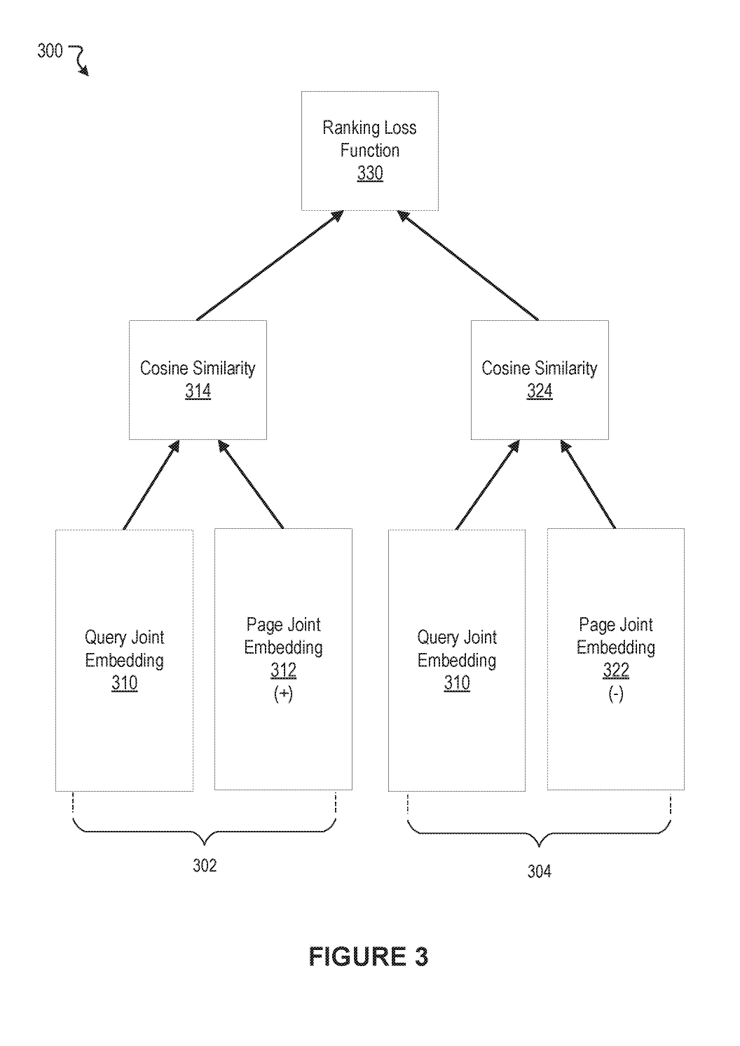

A given query can be represented in the page-query joint space by a first query joint embedding. It can be appreciated that if, for the given query, a first page is selected by users most often, the first page should be represented by a first page joint embedding that is closer to the first query joint embedding in the page-query joint space than any other page joint embedding. For example, the first page joint embedding should have a larger cosine similarity with the first query joint embedding than any other page joint embedding. Similarly, if a second page is selected second most often for the given query, the second page should be represented by a second page joint embedding that is closer to the first query joint embedding than any other page joint embedding except for the first page joint embedding. In order to compute embeddings that are consistent with these desired outcomes, the joint embedding model can employ a ranking loss function. An example scenario is depicted in FIG. 3.

FIG. 3 illustrates an example functional block diagram 300 associated with training a joint embedding model, according to an embodiment of the present disclosure. The functional block diagram 300 includes two query-page pairs 302, 304. A first query-page pair 302 includes a query joint embedding 310 and a first page joint embedding 312. A second query-page pair 304 includes the query joint embedding 310 and a second page joint embedding 322. The query joint embedding 310 is associated with a first query, the first page joint embedding 312 is associated with a first page, and the second page joint embedding 322 is associated with a second page. The first page joint embedding 312 is marked with a (+) and the second page joint embedding 322 is marked with a (−) to indicate that the first page is ranked higher than the second page with respect to the first query. For example, users may have selected the first page as a result of the first query more often than they selected the second page. As such, a cosine similarity 314 for the first query-page pair 302 should be greater than a cosine similarity 324 for the second query-page pair 304. A ranking loss function 330 can be employed to update the joint embeddings (e.g., query joint embedding 310, page joint embedding 312, and/or page joint embedding 322) to ensure that the cosine similarity 314 is greater than the cosine similarity 324. In various embodiments, the ranking loss function 330 can be employed as:

$$L ( q , p ) = {\sum }_{q , + p , - p} max ( 0 , cos ( q , - p ) - cos ( q , + p ) + m )$$

where q is a query joint embedding (e.g., the query joint embedding 310), +p is a higher ranked page joint embedding (e.g., the page joint embedding 312), and −p is a lower ranked page joint embedding (e.g., the page joint embedding 322).

FIG. 4 illustrates an example query results module 402 configured to identify one or more page results for a query, according to an embodiment of the present disclosure. In some embodiments, the query results module 106 of FIG. 1 can be implemented as the query results module 402. As shown in the example of FIG. 4, the query results module 402 can include a distance score module 404 and a page results selection module 406.

The distance score module 404 can be configured to, for a given query, calculate distance scores for a plurality of pages. In various embodiments, when a user enters a query, the distance score module 404 can compute a query joint embedding for the query. For example, the distance score module 404 can compute a query embedding for the query based on a query embedding model, and then compute a query joint embedding based on the query embedding and a joint embedding model. Similarly, page joint embeddings can be computed for a plurality of pages. For example, page embeddings for pages on a social networking system can be computed based on a page embedding model, and page joint embeddings can be computed based on the page embeddings and the joint embedding model.

The distance score for a particular page may be calculated based on a cosine similarity and/or a dot product of a page joint embedding associated with the particular page and the query joint embedding associated with the query. The distance score for a particular page may be indicative of a relevance and/or similarity of the particular page to the given query. If a first page has a larger distance score than a second page with respect to a particular query (e.g., a larger cosine similarity), indicating that the first page's page joint embedding is closer and/or more similar to the particular query's query joint embedding, it can be determined that the first page is more relevant to the particular query than the second page.

The page results selection module 406 can be configured to identify one or more page results for a given query based on distance scores. In certain embodiments, for a given query, a set of pages can be ranked based on distance scores. One or more page results can be selected from the set of pages based on the ranking. For example, the top n pages can be selected as page results. In various embodiments, the top n pages can be added to a reverse index to ensure that they are retrieved when a user enters the given query. In certain embodiments, distance scores may be one feature that is used to rank a set of pages, before the top k pages are presented to a user as page results.

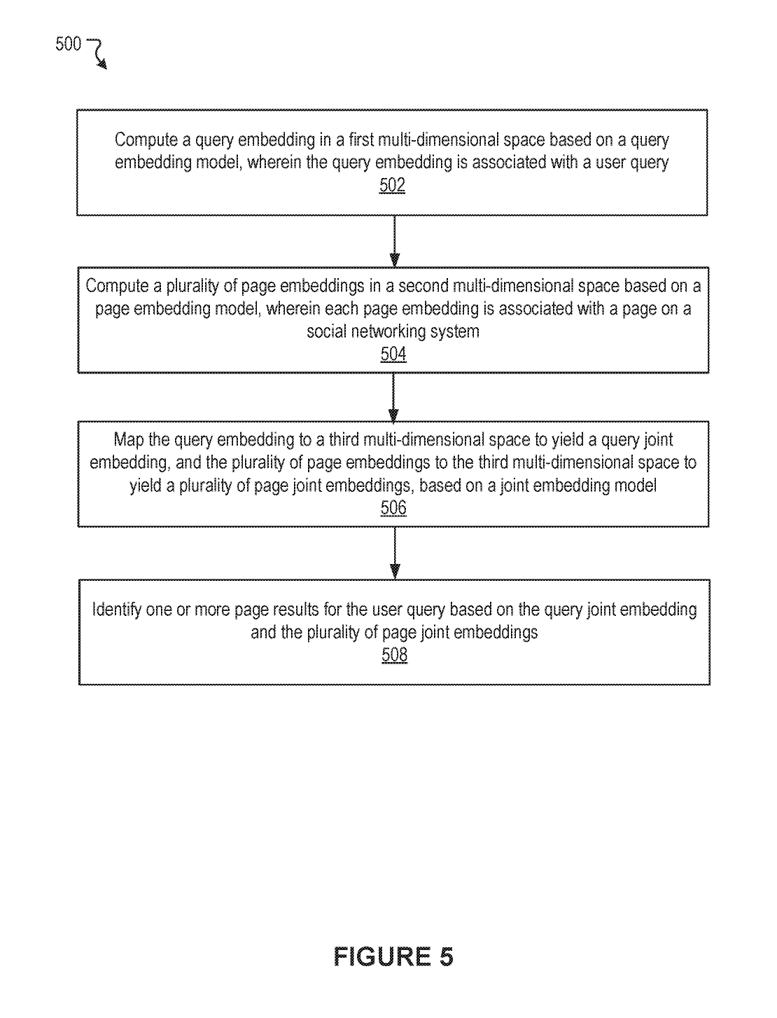

FIG. 5 illustrates an example method 500 associated with identifying one or more page results for a query based on embeddings, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can compute a query embedding in a first multi-dimensional space based on a query embedding model, wherein the query embedding is associated with a user query. At block 504, the example method 500 can compute a plurality of page embeddings in a second multi-dimensional space based on a page embedding model, wherein each page embedding is associated with a page on a social networking system. At block 506, the example method 500 can map the query embedding to a third multi-dimensional space to yield a query joint embedding, and the plurality of page embeddings to the third multi-dimensional space to yield a plurality of page joint embeddings, based on a joint embedding model. At block 508, the example method 500 can identify one or more page results for the user query based on the query joint embedding and the plurality of page joint embeddings.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing engagements between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and engagements with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and engagements.

The social networking system 630 also includes user-generated content, which enhances a user's engagements with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the engagement of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the engagements and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's engagement with an external system 620 from the web server 632. In this example, the external system 620 reports a user's engagement according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing engagements between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include an embeddings-based page query module 646. The embeddings-based page query module 646 can, for example, be implemented as the embeddings-based page query module 102, as discussed in more detail herein. As discussed previously, it should be appreciated that there can be many variations or other possibilities. For example, in some embodiments, one or more functionalities of the embeddings-based page query module 646 can be implemented in the user device 610.

### Hardware Implementation

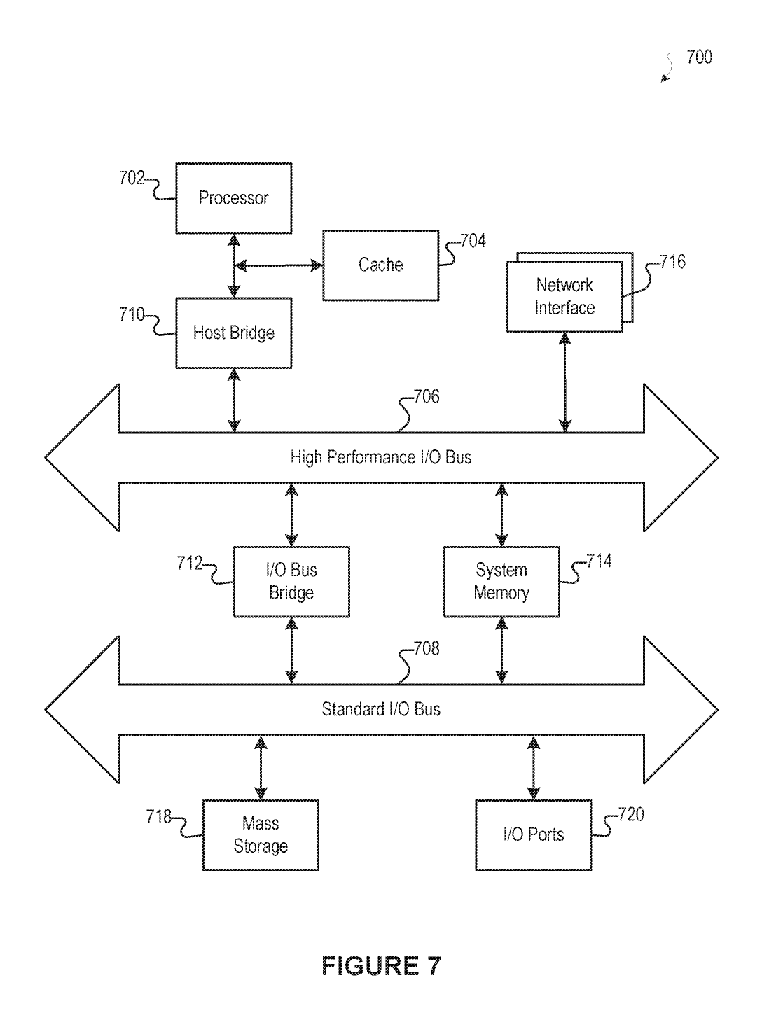

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
computing, by a computing system, a query embedding in a first multi-dimensional space based on a query embedding model, the query embedding associated with a user query;
computing, by the computing system, a plurality of page embeddings in a second multi-dimensional space based on a page embedding model;
computing, by the computing system, a query joint embedding and a plurality of page joint embeddings in a third multi-dimensional space based on the query embedding, the plurality of page embeddings, and a joint embedding model; and
identifying, by the computing system, one or more page results for the user query based on the query joint embedding and the plurality of page joint embeddings.

2. The computer-implemented method of claim 1, wherein
the computing the query joint embedding comprises mapping the query embedding to the third multi-dimensional space based on the joint embedding model, and
the computing the plurality of page joint embeddings comprises mapping the plurality of page embeddings to the third multi-dimensional space based on the joint embedding model.

3. The computer-implemented method of claim 1, further comprising calculating distance scores for each page joint embedding with respect to the query joint embedding, wherein the one or more page results are identified based on the distance scores.

4. The computer-implemented method of claim 3, wherein, for a given page joint embedding, the distance score is calculated based on a cosine similarity of the page joint embedding and the query joint embedding.

5. The computer-implemented method of claim 1, wherein the page embedding model is trained based on a neural linguistic embedding methodology.

6. The computer-implemented method of claim 5, wherein
the page embedding model is trained using page training data,
the page training data comprises a plurality of sentences,
each sentence of the plurality of sentences comprises a sequence of words,
each sentence of the plurality of sentences is associated with a particular user, and
each word in a sentence is associated with a page fanned by the particular user.

7. The computer-implemented method of claim 1, wherein the query embedding model is trained based on query training data comprising a plurality of content posts on a plurality of pages.

8. The computer-implemented method of claim 7, wherein the query embedding model is trained based on a paragraph embedding methodology.

9. The computer-implemented method of claim 8, wherein
the query training data comprises a plurality of paragraphs, each paragraph of the plurality of paragraphs comprising a plurality of sentences, and
for each paragraph in the plurality of paragraphs,
the paragraph is associated with a particular page, and
each sentence in the paragraph is associated with a content post on the particular page.

10. The computer-implemented method of claim 1, wherein the joint embedding model is trained based on a two-stream x2 neural network methodology.

11. A system comprising:
at least one processor; and
a memory storing instructions that, when executed by the at least one processor, cause the system to perform a method comprising:
computing a query embedding in a first multi-dimensional space based on a query embedding model, the query embedding associated with a user query;
computing a plurality of page embeddings in a second multi-dimensional space based on a page embedding model;
computing a query joint embedding and a plurality of page joint embeddings based on the query embedding, the plurality of page embeddings, and a joint embedding model; and
identifying one or more page results for the user query based on the query joint embedding and the plurality of page joint embeddings.

12. The system of claim 11, wherein
the computing the query joint embedding comprises mapping the query embedding to the third multi-dimensional space based on the joint embedding model, and
the computing the plurality of page joint embeddings comprises mapping the plurality of page embeddings to the third multi-dimensional space based on the joint embedding model.

13. The system of claim 11, wherein the method further comprises calculating distance scores for each page joint embedding with respect to the query joint embedding, and the one or more page results are identified based on the distance scores.

14. The system of claim 13, wherein, for a given page joint embedding, the distance score is calculated based on a cosine similarity of the page joint embedding and the query joint embedding.

15. The system of claim 11, wherein the page embedding model is trained based on a neural linguistic embedding methodology.

16. A non-transitory computer-readable storage medium including instructions that, when executed by at least one processor of a computing system, cause the computing system to perform a method comprising:
computing a query embedding in a first multi-dimensional space based on a query embedding model, the query embedding associated with a user query;
computing a plurality of page embeddings in a second multi-dimensional space based on a page embedding model;
computing a query joint embedding and a plurality of page joint embeddings based on the query embedding, the plurality of page embeddings, and a joint embedding model; and
identifying one or more page results for the user query based on the query joint embedding and the plurality of page joint embeddings.

17. The non-transitory computer-readable storage medium of claim 16, wherein
the computing the query joint embedding comprises mapping the query embedding to the third multi-dimensional space based on the joint embedding model, and
the computing the plurality of page joint embeddings comprises mapping the plurality of page embeddings to the third multi-dimensional space based on the joint embedding model.

18. The non-transitory computer-readable storage medium of claim 16, wherein the method further comprises calculating distance scores for each page joint embedding with respect to the query joint embedding, and the one or more page results are identified based on the distance scores.

19. The non-transitory computer-readable storage medium of claim 18, wherein, for a given page joint embedding, the distance score is calculated based on a cosine similarity of the page joint embedding and the query joint embedding.

20. The non-transitory computer-readable storage medium of claim 16, wherein the page embedding model is trained based on a neural linguistic embedding methodology.
